(19) United States
(12) Patent Application Publication
(10) Pub. No.: US 2026/0302928 A1
(43) Pub. Date: Oct. 1, 2026

(54) POWER CONVERSION SYSTEM WITH COMMON MODE FILTER

(71) Applicant: Gamesa Electric, S.A. Unipersonal, Zamudio (ES)

(72) Inventors: Pablo Moreno-Torres Concha, Leganes (ES); Ivan Ruiz Erni, Zaragoza (ES)

(21) Appl. No.: 19/480,851

(22) PCT Filed: Apr. 19, 2024
(86) PCT No.: PCT/EP2024/060717

§ 371 Date: Nov. 3, 2025

(30) Foreign Application Priority Data
May 10, 2023 (EP) 23382437.4

(51) Int. Cl. H02M 1/12; H02M 1/00; H02M 1/10; H02M 3/158; H02M 7/493; H02M 7/5387

(52) U.S. Cl. CPC H02M 1/123; H02M 1/0077; H02M 1/10; H02M 1/126; H02M 3/158; H02M 7/493; H02M 7/5387

(57) ABSTRACT

A power conversion system is provided. The power conversion system includes a first power conversion module, and a second, power conversion module both configured to convert electrical power between a first and a second side of the second power conversion module Each power conversion module includes at least a first and second terminal on the first side that are configured to be coupled to a different power source The power conversion system may further include a common mode filter, wherein the common mode filter comprises includes at least one impedance coupled between the first terminal of the first power conversion module and the first terminal of the second power conversion module, and/or at least one impedance coupled between the second terminal of the first power conversion module and the second terminal of the second power conversion module.

### CROSS-REFERENCE TO RELATED APPLICATIONS

This application is a national stage of PCT Application No. PCT/EP2024/060717, having a filing date of Apr. 19, 2024, which claims priority to EP Application No. 23382437.4, having a filing date of May 10, 2023, the entire contents both of which are hereby incorporated by reference.

### FIELD OF TECHNOLOGY

The following relates to a power conversion system. It further relates to a renewable power generation system comprising such power conversion system and a method of providing a power conversion system.

### BACKGROUND

A power conversion system may be installed in a configuration in which plural power converters operate in parallel and in which each outputs converted electrical power that is provided by a respective power source, e.g., by an energy power storage, for example based on batteries, or by a photovoltaic module, to a common electrical bus. However, in such a configuration, common mode currents and voltage (common mode noise) may occur and flow between the power sources. The common mode currents are unwanted since they are harmful to the components of the power conversion system, e.g., by damaging the insulation of the system components. For example, the peak-to-peak voltage between a positive terminal of a power source and ground or the negative terminal of the power source and ground may increase due to occurring common mode noise and result in a degradation of its insulation system. Therefore, to prevent or at least reduce the common mode noise, common mode filters are used today. The common mode filters are usually implemented by additional capacitive and/or inductive components that compensate the parasitic capacities of each power source terminal since the high capacitive value of the parasitic capacities has a significant influence on the amount of created common mode current in the power conversion system. However, due to the high capacitive value of the parasitic capacities, the common mode voltage and current frequencies to be filtered are relatively low such that the capacitive and/or inductive components of the common mode filter must be designed to provide a correspondingly high value, resulting in large and heavy components and/or a high number of components and therefore also in high costs. Moreover, the effectiveness of today's common mode filters is limited during operation.

The document KR 2023 0036471 A describes two power converters connected in parallel between a wind turbine generator and a power grid. To avoid common mode currents caused by voltage measurement error and imbalance between the DC links of the parallel power converters, it is proposed to provide a coupling inductor between the DC links in order to match the DC component of the voltage of the first DC link and the second DC link.

### SUMMARY

An aspect relates to a power conversion system that counters common mode noise with a more effective operating common mode filter that is reduced in size/weight and/or composed from a reduced number of components and may thus be provided at lower costs.

According to an aspect of embodiments of the invention, a power conversion system is provided. The power conversion system may comprise a first power conversion module configured to convert electrical power between a first side and a second side of the first power conversion module, and a second, different, power conversion module configured to convert electrical power between a first side and a second side of the second power conversion module. Each power conversion module may comprise at least a first terminal and a second terminal on the first side that are configured to be coupled to a different power source. The second side of each power conversion module may be coupled to a common electrical bus. The power conversion system may further comprise a common mode filter configured to filter common mode currents circulating between the first power conversion module and the second power conversion module via the common electrical bus, wherein the common mode filter comprises at least one impedance coupled between the first terminal of the first power conversion module and the first terminal of the second power conversion module, and/or at least one impedance coupled between the second terminal of the first power conversion module and the second terminal of the second power conversion module.

Optionally, the at least one impedance may be directly coupled between the first terminal of the first power conversion module and the first terminal of the second power conversion module and/or the at least one impedance may be directly coupled between the second terminal of the first power conversion module and the second terminal of the second power conversion module. Optionally, the respective at least one impedance may be a capacitive impedance that comprises a capacitor. Such capacitor may be a circuit element that is connected between the respective first terminals or between the respective second terminals.

The at least one impedance of the common mode filter (herein also referred to as “bridging impedance”) creates one or more alternative paths or bridges between the terminals of each power conversion module and, thus, between the terminals of each connected power source. As a result, at least a part of the current flowing between the power sources via their parasitic capacities and via ground may flow via the created paths or bridges, bypassing the parasitic capacities of the power sources and reducing the amount of common mode current that is directly injected to ground.

Due to the implementation of the bridging impedances, components of the common mode filter providing the required capacitance and/or inductance of the filter may be reduced in size and/or number. Therefore, the common mode filter may be provided having a smaller size and weight and less complexity, which also reduces the effort of its provision.

Moreover, capacitive components of the common mode filter that are ground connected are usually limited due to standards defining a maximum of current that is allowed to be injected to ground. However, bypassing the ground-injecting power flow path by the bridging impedances allows increasing the capacity of the common mode filter by the capacitive components of the bridging impedances while decreasing the inductive components of the common mode filter without the need of increasing the ground-connected capacitive components. Since the inductive components usually require more space and are heavier compared to the capacitive components. In other words, without changing the characteristic of and/or requirements for the common mode filter (e.g., a second or higher order low pass filter, as e.g., a LC or RLC filter with a specific performance), which is based on the capacitive and inductive components, the filter may be reduced in size and weight.

Furthermore, since currents may directly flow between the power sources via alternative paths or bridges, the common mode filter may also operate more effectively. Particularly, a common mode filter comprising a topology as described herein may filter more common mode noise than a common mode filter comprising a conventional topology.

It should be clear that a different power conversion module or power source may herein refer to a separate entity of the power conversion modules or power sources. In other words, the different power conversion modules may be different(separate) components which may or may not be of the same type. Likewise, the different power sources may be different(separate) components which may or may not be of the same type.

The respective at least one impedance may not comprise a circuit element in form of an inductor. The first terminals may not be directly connected together (e.g., via a conductor), and/or the second terminals may not be directly connected together (e.g., via a conductor). This may allow independent operation of the DC side inputs of the first and second power conversion modules, e.g., using different power sources as input.

In an embodiment, the at least one impedance may be connected, in particular directly connected, between the first terminal of the first power conversion module and the first terminal of the second power conversion module. Additionally or alternatively, the at least one impedance may be connected, in particular directly connected, between the second terminal of the first power conversion module and the second terminal of the second power conversion module.

The power conversion modules may convert from direct current (DC) electrical power to alternating current (AC) electrical power or to direct current electrical power. For example, the power conversion modules may comprise one or more DC-AC converters which comprise a two or multilevel topology or may comprise one or more DC-DC converters which comprise a boost or buck topology.

In an embodiment, the power sources may be direct current power sources. In an embodiment, at least one of the direct current power sources is a (bidirectional) energy storage system, e.g., based on a battery or based on an alternative energy storage unit, or a photovoltaic system.

Each power conversion module may be configured to be coupled to at least a first terminal and a second terminal of the respective/associated power source. In an embodiment, the at least first and second terminals of the power source may comprise a positive terminal and/or a negative terminal, e.g., a cathode and/or an anode, e.g., in the case the power source being a battery.

In an embodiment, each of a part of the power sources may be an energy storage system and each of a further part of the power sources may be a photovoltaic system.

The common electrical bus may be a direct current or alternating current bus.

The at least first and second terminals of the power conversion modules may be direct current terminals. Alternatively or additionally, the first side of the power conversion modules may be a direct current side configured to exchange direct current electrical power with the respective power source.

In an embodiment, at least one of the (bridging) impedances may be a capacitive impedance.

For example, the least one impedance may comprise a capacitor. The capacitor may in some examples be directly connected between the first terminal of the first power conversion module and the first terminal of the second power conversion module and/or the capacitor may be directly connected between the second terminal of the first power conversion module and the second terminal of the second power conversion module, respectively. This may allow independent operation of the first and second power conversion modules with different power sources on their first side while efficiently reducing common mode noise that may otherwise result in currents through the parasitic capacitances of the different (e.g., first and second) power sources.

A respective capacitor may comprise one or more capacitances connected in series and/or in parallel. A direct connection may comprise respective conductors and connectors to establish the connection.

In another example, at least one of the impedances may additionally or alternatively be resonant or not resonant and/or may include passive components and/or damping structures. In a particular example, the capacitive impedance may comprise only a capacitor.

At least one of the impedances may comprise a capacitor and a resistor, in particular a high-value resistor. In an embodiment, the resistor may be configured to be controllable to discharge the capacitor. For example, to control the discharge, the resistor may be configured to be controllable to couple and decouple with the capacitor, e.g., by a controllable switch.

In an embodiment, the first power conversion module and/or second power conversion module may be configured to convert between direct current electrical power and alternating current electrical power or between direct current electrical power and direct current electrical power.

The first terminal of each power conversion module may be a positive terminal configured to be coupled to a positive terminal of the respective power source and the second terminal of each power conversion module may be a negative terminal configured to be coupled to a negative terminal of the respective power source. Each of the positive terminals may have a higher electric potential than the associated negative terminal. For example, when the power source is a battery, the positive and negative terminals may be terminals that are coupled or connected, in particular directly connected, with a positive pole and negative pole of the battery, respectively.

In an embodiment, the power conversion system may be configured to operate the first power conversion module with a DC voltage level on its first side that is independent from a DC voltage level on the first side of the second power conversion module. In an embodiment, the respective DC voltage level may depend on the electrical power provided by the respective power source to the first side of the respective power conversion module. This may allow independent operation in accordance with the amount of electrical power provided by the different power sources, e.g., different batteries, to the first side of the respective power conversion module, e.g., with the electrical power fed by the respective power source to the first and second terminals on the first side of the respective power conversion module. The power conversion system may thus for example operate with different kinds of batteries or different charging levels of the batteries, or with different solar panels that may provide different amounts of electrical power to the DC side of the power conversion modules.

The impedance of the common mode filter may be configured to reduce common mode currents through a parasitic capacitance of the respective power source coupled to the respective first and second terminals of the respective power conversion module. The risk of damage to an insulation of the respective power source may thereby be reduced.

In an embodiment, the common mode filter may further comprise one or more inductors, in particular one or more common mode inductors, that are electrically coupled or connected, in particular directly connected, with one or more terminals on the second side of at least one of the power conversion modules. Additionally or alternatively, the common mode filter may further comprise one or more inductors, in particular one or more common mode inductors, that are electrically coupled or connected, in particular directly connected, with one or more terminals on the first side of at least one of the power conversion modules.

At least a part of the one or more inductors of each power conversion module that are coupled with the one or more terminals on the first side and/or that are coupled with the one or more terminals on the second side may or may not be electrically coupled with each other.

The common mode inductors or common mode chokes may for example comprise plural coils of insulated wire on a single magnetic core. Each winding may be electrically coupled, e.g., connected in series, with one of the terminals.

The common mode filter may further comprise one or more capacitors that are electrically coupled or connected, in particular directly connected, with one or more terminals on the first side of at least one of the power conversion modules.

In an embodiment, each of the one or more capacitors may be coupled or connected, in particular directly connected, with at least one of the one or more inductors of the first side. Additionally or alternatively, the one or more capacitors and/or the one or more inductors of the first side may be coupled or connected, in particular directly connected, with ground.

The power conversion system may further comprise one or more further respective power conversion modules, wherein the second side of the one or more further power conversion modules may be coupled to the common electrical bus. The common mode filter may comprise for each of the one or more further power conversion modules at least one impedance coupled or connected, in particular directly connected, between the first and/or second terminal of the power conversion module and a first and/or second terminal, respectively, of another power conversion module.

In an embodiment, the power conversion modules may comprise modules of identical or different type, and/or the power sources may comprise power sources of identical or different type. For example, the power conversion module may comprise a power conversion module configured to convert electrical power that is output by a battery and a power conversion module that is configured to convert electrical power that is output by a photovoltaic system.

According to an aspect of embodiments of the invention, a system is provided. In embodiments, the system comprises at least a first and a second, different, power source and further comprises any of the power conversion systems described herein. The at least first and second power source may be electrically coupled or connected, in particular directly connected, with respective terminals of the power conversion system.

In an embodiment, the system may be a battery system and/or the at least first and second power sources may be batteries or cells. The batteries or cells of embodiments of the system may constitute a battery rack.

According to an aspect of embodiments of the invention, a renewable power generation system is provided. The renewable power generation system may comprise any of the power conversion systems described herein. The renewable power generation system may comprise at least two power sources each configured to provide electrical power, in particular DC electrical power, at a power terminal, wherein the power terminal of each of the at least two power sources is electrically coupled to terminals of a first side of associated power conversion modules of the power conversion system.

The renewable power generation system may be a wind power plant or a photovoltaic power plant or a combination of a wind power plant or a photovoltaic power plant.

According to an aspect of embodiments of the invention, a method of providing a power conversion system is provided. In embodiments, the method may comprise providing a first power conversion module configured to convert electrical power between a first side and a second side of the first power conversion module. In embodiments, the method may comprise providing a second, different, power conversion module configured to convert electrical power between a first side and a second side of the second power conversion module, wherein each power conversion module comprises at least a first terminal and a second terminal on the first side that are configured to be coupled to a different power source, and wherein the second side of each power conversion module is coupled to a common electrical bus. In embodiments, the method may further comprise providing a common mode filter configured to filter common mode currents circulating between the first power conversion module and the second power conversion module via the common electrical bus, wherein the common mode filter comprises at least one impedance coupled between the first terminal of the first power conversion module and the first terminal of the second power conversion module, and/or at least one impedance coupled between the second terminal of the first power conversion module and the second terminal of the second power conversion module.

It is to be understood that the features mentioned above and those yet to be explained below can be used not only in the respective combinations indicated, but also in other combinations or in isolation, without leaving the scope of embodiments of the present invention. In particular, the features of the different aspects and embodiments of the invention can be combined with each other unless noted to the contrary.

It should be clear that all method features or functional features are without limitation applicable as a feature in isolation, as a combination of features, or in any sub-combination in a device or system described herein and are disclosed hereby. Likewise, all device or system features or structural features are without limitation applicable as a feature in isolation, as a combination of features, or in any sub-combination to a method described herein and are disclosed hereby.

### BRIEF DESCRIPTION

Some of the embodiments will be described in detail, with references to the following Figures, wherein like designations denote like members, wherein:

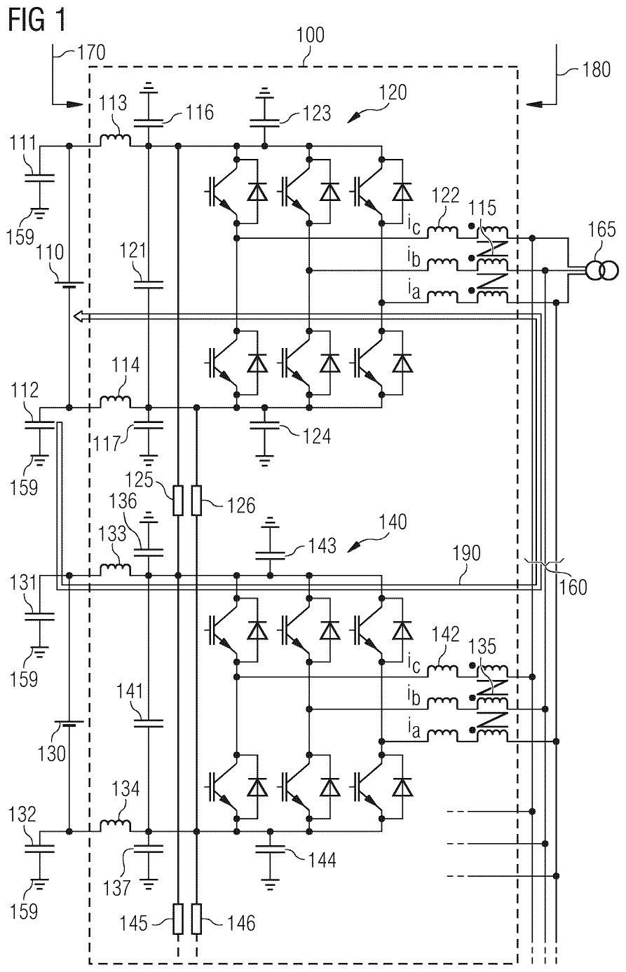

FIG. 1 is a schematic drawing illustrating a power conversion system including a common mode filter according to an exemplary implementation;

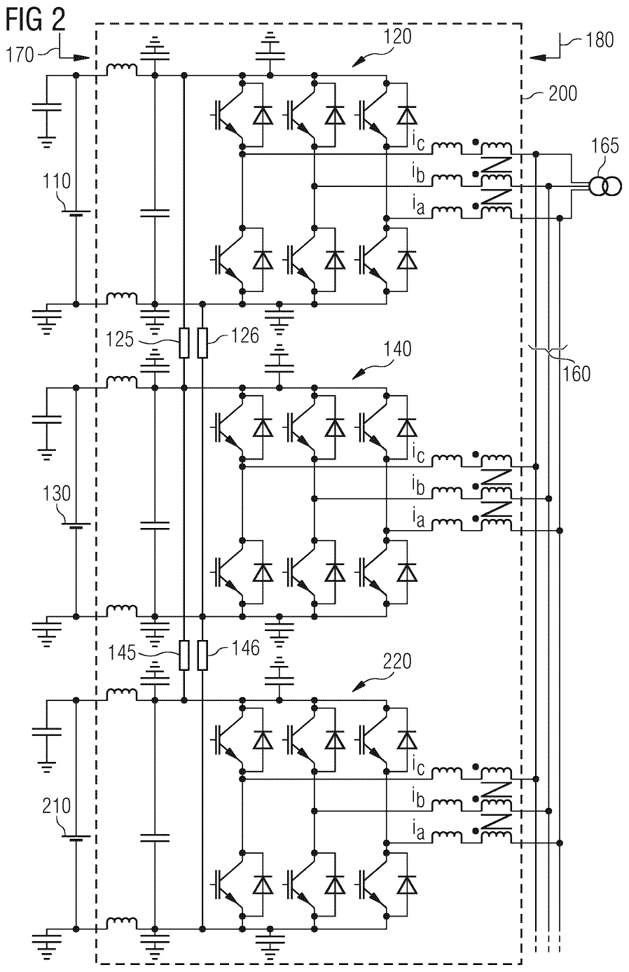

FIG. 2 is a schematic drawing illustrating a power conversion system including a common mode filter according to a further exemplary implementation;

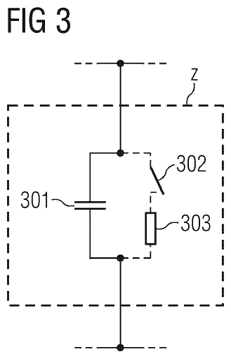

FIG. 3 is a schematic drawing illustrating an impedance of the common mode filter according to an exemplary implementation;

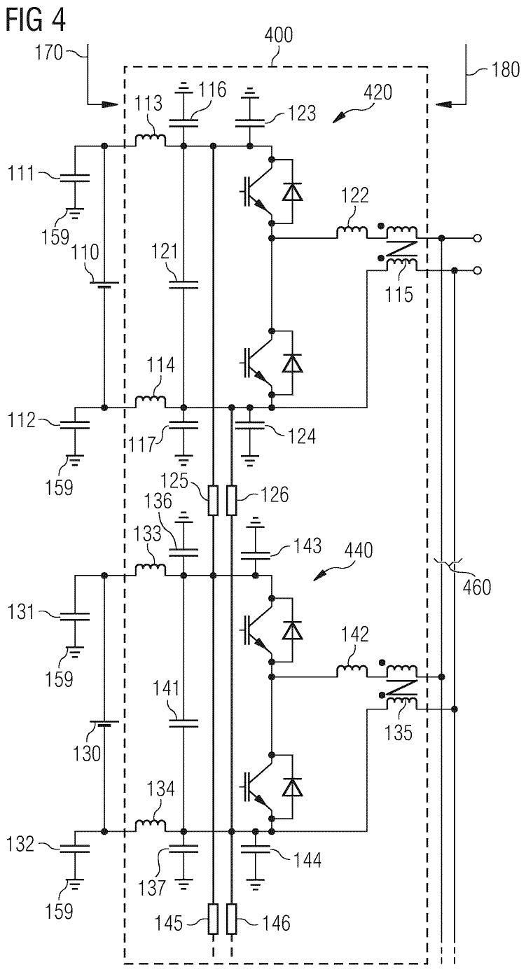

FIG. 4 is a schematic drawing illustrating a power conversion system including a common mode filter according to a further exemplary implementation; and

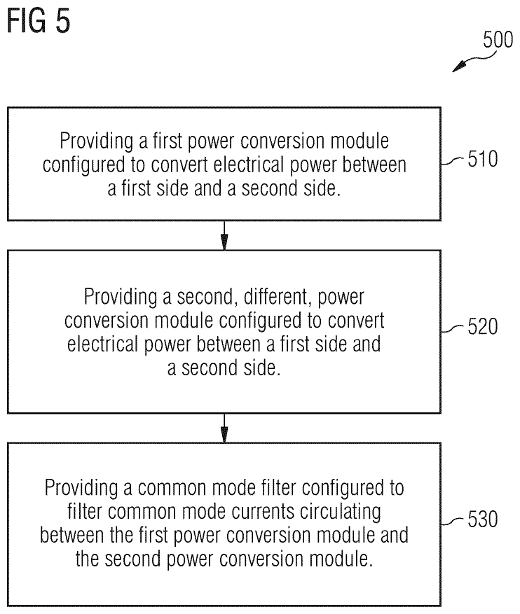

FIG. 5 is a schematic flow diagram illustrating a method of providing a power conversion system according to an exemplary embodiment.

### DETAILED DESCRIPTION

In the following, embodiments of the invention will be described in detail with reference to the accompanying drawings. It is to be understood that the following description of the embodiments is given only for the purpose of illustration and is not to be taken in a limiting sense. It should be noted that the drawings are to be regarded as being schematic representations only, and elements in the drawings are not necessarily to scale with each other. Rather, the representation of the various elements is chosen such that their function and general purpose become apparent to a person skilled in the art. As used herein, the singular forms “a,” “an,” and “the” are intended to include the plural forms as well, unless the context clearly indicates otherwise. The terms “comprising,” “having,” “including,” and “containing” are to be construed as open-ended terms (i.e., meaning “including, but not limited to,”) unless otherwise noted.

FIG. 1 is a schematic drawing illustrating a power conversion system 100 including a common mode filter according to an exemplary implementation.

The power conversion system 100 may comprise at least two parallel operating power conversion modules 120, 140 being configured to convert electrical power of at least two respective power sources 110, 130. Each power conversion module 120, 140 may comprise a first side 170 and a second side 180. On the first side 170 and on the second side 180, the power conversion modules 120, 140 may comprise capacitors 121, 141 and inductors 122, 142. The components 121, 141, 122, 142 may serve filtering, e.g., smoothing, the electrical power that passes the power conversion modules 120, 140 for the purpose of its conversion. The power conversion module 120, 140 may be electrically coupled on the first side 170 to the power sources 110, 130, respectively. The power sources 110, 130 may be DC sources, in particular energy storage systems, e.g., based on (floating) batteries. On the second side 180, each power conversion module 120, 140 may be electrically coupled with the same common electrical bus 160. The electrical bus may be electrically coupled to a transformer 165 by which electrical power is exchanged with another source or load (not shown in FIG. 1) that is electrically coupled with the transformer 165, e.g., electrical power may be exchanged with an auxiliary system of a renewable energy generation system comprising the power conversion system 100.

Although the common mode filter is applicable on other types of power conversion modules, as an example, each of the power conversion modules 120, 140 shown in FIG. 1 may be a two-level three-phase DC-AC converter. The DC-AC converters may for example be power switch, e.g., IGBT, based. Accordingly, the common electrical bus 160 to which the power conversion modules 120, 140 are electrically coupled on the second side may be a common AC electrical bus.

The common bus 160 may be configured to allow a flow of electrical power between the at least two power conversion modules 120, 140, i.e., the power conversion modules 120, 140 may not be electrically isolated from each other on the second side 180.

The power conversion system 100 may comprise a common mode filter. The common mode filter may be configured to filter the common mode noise occurring during operation in the power conversion system 100.

The common mode noise may include common mode current that flows during operation of the power conversion modules 120, 130 via ground-connected parasitic capacitances 111, 112, 131, 132 of the power sources 110, 130 (each parasitic capacitance is connected to a terminal of a power source) and ground-connected parasitic capacitances 123, 124, 143, 144 of the power conversion modules 120, 140, via the ground and via the common bus 160. Since the parasitic capacitances 111, 112, 131, 132 of the power sources 110, 130 are much higher than the parasitic capacitances 123, 124, 143, 144 of the power conversion modules 120, 140, a majority of the electrical power of the common mode noise may flow via parasitic capacitances 111, 112, 131, 132 which makes the electrical power that takes this flow path to the most relevant subject of the common mode filter. More specifically and as indicated by power flow path 190, the major part electrical power of the common mode noise to be filtered may for example flow from the terminals, e.g., the positive and negative terminals, of power source 110 via parasitic capacities 111, 112 to ground 159 and from ground 159 via parasitic capacities 131, 132 to the terminals of power source 130, and via the common bus 160 back to the terminals of power source 110.

It should be clear that the electrical couplings with ground shown in the figures (whether or not the respective ground symbols are designated by reference 159) may be electrically coupled to the same ground.

In general, the common mode noise, i.e., also this electrical power flow through ground, when not properly filtered, may cause a harmful increase in the peak-to-peak voltage between terminals of the power sources and ground, thus damaging the power sources, e.g., their insulation. This may be especially relevant for systems in which one or more power sources have much higher parasitic capacities to ground than the remaining system components.

To reduce the power flow to ground, the common mode noise may be filtered by a common mode filter, as comprised by power conversion system 100.

The common mode filter of the power conversion system 100 may comprise (bridging) impedances 125, 126 which electrically couple the first and second terminals of the power conversion modules 120, 140 on the first side 170.

It should be clear that the common mode filter may comprise further bridging impedances for each further power conversion module, wherein the further bridging impedances correspondingly electrically couple further first and second terminals of the further power conversion module with the terminals of the remaining power conversion modules, as exemplarily indicated by impedances 145, 146. For example, when the power conversion system 100 comprises three power conversion modules each comprising two terminals, four bridging impedances may be implemented, as shown in FIG. 2. Or, as a further example, when the power conversion system 100 comprises four power conversion modules each comprising two terminals, six bridging impedances may be implemented.

This way, the terminals of the power conversion modules 120, 140 and, thus, of the power sources are electrically connected/coupled via the impedances with each other while the impedances basically operate as electrical bridges between the terminals. As a result, an alternative path for the power flow of the common mode noise (voltage, current) may be created between the terminals, directly reducing the amount of electrical power injected to ground and allowing an improved design of the common mode filter which for example has reduced weight, size and/or complexity.

The common mode filter may further comprise filtering inductors 113, 114 and filtering inductors 133, 134 that are electrically coupled to the first and second terminals on the first side 170 of the power conversion modules 120, 140, respectively. Additionally or alternatively, the common mode filter may comprise common mode (filtering) inductors/chokes 115, 135 that electrically couple the terminals of the power conversion modules 120, 140 on the second side 180, respectively.

It should be clear that the filtering inductors may be coupled or not coupled with each other. For example, the inductors 113, 114 and the inductors 133, 134 may alternatively be coupled with each other, respectively, and/or constitute common mode (filtering) inductors/chokes. Similarly, for example, the inductors included in the respective common mode (filtering) inductors/chokes 115, 135 may alternatively be non-coupled.

The common mode filter may further comprise filtering capacitors 116, 117, 136, 137 that electrically couple the terminals of the power conversion modules 120, 140 on the first side 170 via the inductors 113, 114, 133, 134 with ground, respectively.

It should be clear that, when the further power conversion modules are implemented, the common mode filter may comprise corresponding filtering inductances and capacities for each of the further power conversion modules.

The common mode filter may be configured to operate as a low pass filter, e.g., as a low-pass filter of second or higher order. In an embodiment, the dynamic of the filter, i.e., its characteristic time constants, may be set based on one or more frequencies of the common mode noise.

FIG. 2 is a schematic drawing illustrating a power conversion system 200 including a common mode filter according to a further exemplary implementation. The power conversion system 200 differs from the power conversion system 100 in that the power conversion system 200 further comprises power conversion module 220. The power conversion module 220 is electrically coupled with a further power source 210. In other words, the power conversion system 200 consists of exactly three power conversion modules 120, 140, 220 which are electrically coupled with three different power sources 110, 130, 210, respectively. As can be seen in FIG. 2, the impedance 145, 146 may electrically couple the first and second terminals of the power conversion modules 140, 220 on the first side 170 and, thus, the corresponding first and second terminals of the power sources 130, 210.

As outlined above, any number of further power conversion modules, e.g., a total number of power conversion modules greater or equal to four, seven or even ten or more, may be electrically coupled with each other correspondingly by using further bridging impedances. That any number of power conversion modules may be electrically coupled with each other by respective bridging impedances is also indicated by the dashed connecting lines of the circuit in FIG. 1, for example, those arranged below impedances 145, 146.

FIG. 3 is a schematic drawing illustrating an impedance z of any of the common mode filters described herein according to an example implementation. The impedance z may for example be at least one of impedances 125, 126, 145, 146 shown in FIGS. 1, 2, or 4.

In general, each of the bridging impedances 125, 126, 145, 146 may comprise (and, thus, may be defined/set by) at least one of one or more capacitors, resistors, and inductors. With these components, each bridging impedance may be adapted to be resonant or non-resonant and/or to include damping structures. The impedance may also include passive components. Moreover, with the components of each impedance the dynamic of the common mode filter may be adapted, e.g., such that the common mode filter may operate as a low-pass filter, in particular as a second or higher order low-pass filter.

However, in the desired implementation shown in FIG. 3, the impedance z may be a capacitive impedance. The impedance may comprise only a capacitor 301 or, alternatively, the capacitor 301 and a (high value) resistor 303. The resistor 303 electrically coupled in parallel with the capacitor 301 may be configured to be controllable, e.g., by switch 302, to discharge the capacitor 302. For this purpose, the switch 302 may be configured to be switchable, e.g., in response to a respective control signal, between a closed state and an open state.

Using such a implementation of the impedance, in particular an impedance comprising the capacitor 301 and the resistor 303 to discharge the capacitor 301 when necessary, the filtering performance of a conventional common mode filter may be achieved by using a reduced value of capacitance and/or inductance. For example, in a power conversion system that includes two parallel operating power sources and associated power conversion modules, the value of capacitance and/or inductance may be reduced to a value up to four times less than the required value of inductance and/or capacity of a comparable conventional common mode filter. It follows that the size and weight of a such common mode filter and/or the number of components composing such a filter may be reduced and that, therefore, its complexity and the effort required to provide such filter may also be reduced.

FIG. 4 is a schematic drawing illustrating a power conversion system 400 including a common mode filter according to a further exemplary implementation. While the power conversion systems 100, 200 are configured to convert DC electrical power to AC electrical power, the power conversion system 400 may be configured to convert the DC electrical power provided by at least the power sources 110, 130 to DC electrical power having a different voltage and current level. The converted DC electrical power may be output to a common DC electrical bus 460. For this purpose, the power conversion modules 420, 440 may convert voltage and current provided by the power sources 110, 130 to voltage and current of a different level, respectively. For example, the power conversion modules 110, 130 may be a boost converter (step-up converter) and/or, as shown in FIG. 3, a buck converter (step-down converter).

To reduce the impact of common mode noise, as outlined above with respect to FIG. 1, the power conversion system 400 comprises a common mode filter. As can be seen in FIG. 4, the common mode filter of the DC/DC power conversion system 400 corresponds to that of the DC/AC power conversion systems 100, 200.

Accordingly, the filter may comprise the bridging impedances 125, 126 which electrically couple the respective first and second terminals of the power conversion modules 120, 140 on the first side 170.

The common mode filter may further comprise the inductors 113, 114 and the inductors 133, 134 that are electrically coupled to the first and second terminals of the power conversion modules 420, 440 on the first side 170, respectively. Additionally or alternatively, the common mode filter may comprise the common mode inductors 115, 135 that electrically couple the terminals of the power conversion modules 420, 440 on the second side 180, respectively.

The common mode filter may further comprise the capacitors 116, 117, 136, 137 that electrically couple the terminals of the power conversion modules 420, 440 on the first side 170 via the inductors 113, 114, 133, 134 with ground, respectively.

The DC electrical power that is output by the power sources 110, 130 to the common DC electrical bus 460 may be provided to another source or to a load (not shown in FIG. 4), e.g., to an auxiliary system of a renewable energy generation system comprising the power conversion system 400.

In view of the above, it should be clear that the common mode filter described herein is applicable for common mode filtering in any power conversion system that comprises a modular structure and at least one common bus. For example, the modular structure may include any type of parallel operating power conversion modules (e.g., DC-AC or DC-DC) with any type of module specific topology (e.g., two-level/multi-lever, or buck or boost).

FIG. 5 is a schematic flow diagram illustrating a method 500 of providing a power conversion system according to an exemplary embodiment. The power conversion system may for example be any of the power conversion systems 100, 200, 400.

It should be clear that the sequence of method steps of embodiments of the method 500 are not limited to the described sequence. Further, embodiments of the method 500 are not limited to a described number of method steps. One or more steps of a described method may be substituted, extended or not performed. Further method steps may be added.

According to a step 510 of method 500, embodiments of the method may comprise providing a first power conversion module configured to convert electrical power between a first side and a second side of the first power conversion module. According to a step 520, the method may comprise providing a second, different, power conversion module configured to convert electrical power between a first side and a second side of the second power conversion module, wherein each power conversion module comprises at least a first terminal and a second terminal on the first side that are configured to be coupled to a different power source, and wherein the second side of each power conversion module is coupled to a common electrical bus. According to a step 530, embodiments of the method may further comprise providing a common mode filter configured to filter common mode currents circulating between the first power conversion module and the second power conversion module via the common electrical bus, wherein the common mode filter comprises at least one impedance coupled between the first terminal of the first power conversion module and the first terminal of the second power conversion module, and/or at least one impedance coupled between the second terminal of the first power conversion module and the second terminal of the second power conversion module.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A power conversion system comprising:
a first power conversion module configured to convert electrical power between a first side and a second side of the first power conversion module,
a second, different, power conversion module configured to convert electrical power between a first side and a second side of the second power conversion module,
wherein each power conversion module comprises at least a first terminal and a second terminal on the first side, wherein each power conversion module is configured to be coupled to a different power source on its first side by its first and second terminals, and wherein the second side of each power conversion module coupled to a common electrical bus, and
a common mode filter configured to filter common mode currents circulating between the first power conversion module and the second power conversion module via the common electrical bus, wherein the common mode filter comprises at least one impedance directly coupled between the first terminal of the first power conversion module and the first terminal of the second power conversion module wherein the at least one impedance is a capacitive impedance that comprises a capacitor and/or at least one impedance directly coupled between the second terminal of the first power conversion module and the second terminal of the second power conversion module, wherein the at least one impedance is a capacitive impedance that comprises a capacitor

2. The power conversion system of claim 1, wherein the power sources )are direct current power sources, wherein at least one of the direct current power sources is an energy storage system or a photovoltaic system.

3. The power conversion system of claim 1, wherein the at least first and second terminals of the power conversion modules are direct current terminals, and/or
wherein the first side of the power conversion modules is a direct current side configured to exchange direct current electrical power with the respective power source.

4. The power conversion system of claim 1, wherein the capacitor is directly connected between the first terminal of the first power conversion module and the first terminal of the second power conversion module and/or wherein the capacitor is directly connected between the second terminal of the first power conversion module and the second terminal of the second power conversion module, respectively.

5. The power conversion system of claim 1, wherein the capacitive impedance comprises only the capacitor.

6. The power conversion system of claim 1, wherein at least one of the impedances comprises the capacitor and a resistor, wherein the resistor is configured to be controllable to discharge the capacitor.

7. The power conversion system of claim 1, wherein the first power conversion module and/or second power conversion module is configured to convert between direct current electrical power and alternating current electrical power or between direct current electrical power and direct current electrical power.

8. The power conversion system of claim 1, wherein the power conversion system is configured to operate the first power conversion module with a DC voltage level on its first side that is independent from a DC voltage level on the first side of the second power conversion module.

9. The power conversion system of claim 1, wherein the common mode filter further comprises one or more common mode inductors that are electrically coupled with one or more terminals on the second side of at least one of the power conversion modules, and/or
wherein the common mode filter further comprises one or more inductors, one or more common mode inductors, that are electrically coupled with one or more terminals on the first side of at least one of the power conversion modules.

10. The power conversion system of claim 1, wherein the common mode filter further comprises one or more capacitors that are electrically coupled with one or more terminals on the first side of at least one of the power conversion modules.

11. The power conversion system of claim 1, wherein the power conversion system further comprises one or more further respective power conversion modules, wherein the second side of the one or more further power conversion modules is coupled to the common electrical bus, and wherein the common mode filter comprises for each of the one or more further power conversion modules at least one impedance coupled between the first and/or second terminal of the power conversion module and a first and/or second terminal, respectively, of another power conversion module

12. The power conversion system of any claim 1, wherein the respective at least one impedance does not comprise a circuit element in form of an inductor.

13. A renewable power generation system, wherein the power generation system comprises a power conversion system according to claim 1, wherein the renewable power generation system comprises at least two power sources each configured to provide electrical power at a power terminal, wherein the power terminal of each of the at least two power sources is electrically coupled to terminals of a first side of associated power conversion modules of the power conversion system

14. The renewable power generation system of claim 13, wherein the renewable power generation system is a wind power plant or a photovoltaic power plant or a combination of a wind power plant and a photovoltaic power plant.

15. A method of providing a power conversion system, wherein the method comprises
providing a first power conversion module configured to convert electrical power between a first side and a second side of the first power conversion module,
providing a second, different, power conversion module configured to convert electrical power between a first side and a second side of the second power conversion module,
wherein each power conversion module comprises at least a first terminal and a second terminal on the first side, wherein each power conversion module is configured to be coupled to a different power source on its first side by its first and second terminals, and wherein the second side of each power conversion module is coupled to a common electrical bus, and
providing a common mode filter configured to filter common mode currents circulating between the first power conversion module and the second power conversion module via the common electrical bus wherein the common mode filter comprises at least one impedance directly coupled between the first terminal of the first power conversion module and the first terminal of the second power conversion module, wherein the at least one impedance is a capacitive impedance that comprises a capacitor, and/or at least one impedance directly coupled between the second terminal of the first power conversion module and the second terminal of the second power conversion module, wherein the at least one impedance is a capacitive impedance that comprises a capacitor.
